(19) United States
(12) Patent Application Publication
(10) Pub. No.: US 2008/0108026 A1
(43) Pub. Date: May 8, 2008

(54) Use of monetary terms to represent energy units

(75) Inventor: Russ E. Lindemann, Valders, WI (US)

Correspondence Address: Russ E. Lindemann, PO Box 340, Manitowoc, WI, 54221-0340, US

(73) Assignee: Russ E. Lindemann, Valders, WI (US)

(21) Appl. No.: 11/593,878

(22) Filed: Nov. 6, 2006

(51) Int. Cl. G09B 19/00

(52) U.S. Cl. 434/127

(57) ABSTRACT

Disclosed is a method of referring to any unit of energy as a monetary system methodology and/or any monetary system methodology language or simile of any monetary system methodology and/or any monetary system methodology language such as 1 BTU (British Thermal Unit) equals 1 Shekel or 1 U.S. dollar.

### REFERENCE TO SEQUENCE LISTING, A TABLE, OR A COMPUTER PROGRAM LISTING COMPACT DISC APPENDIX

Not Applicable

### BACKGROUND OF INVENTION

### Field of Endeavor

This invention relates to any method, system, process, or procedure to use any monetary system methodology and/or any monetary system methodology language or simile of any monetary system methodology and/or any monetary system methodology language to refer to energy units in any scientific field, more particularly the medical field.

One prominent instance for use of this method of using a monetary system methodology language to refer to an energy unit is the medical heath field where the citizens of this country as well as the rest of the world often find it difficult to understand the amount of energy being consumed and equating that with their daily energy needs often resulting in confusion and ambiguity which has been resulting in a world-wide obesity epidemic, most notably, in the United States of America.

### BRIEF SUMMARY OF INVENTION

A method, system, process, or procedure of tracking, recording, calculating, or, otherwise, working with energy units (such as: kilocalorie (Kcal, large calorie, 1000 small calories) or calorie (cal, small calorie) or the general public perceived calorie), where a given monetary unit is equal to one energy unit.

### BRIEF DESCRIPTION OF THE SEVERAL VIEWS OF THE DRAWING

Not Applicable

### DETAILED DESCRIPTION OF THE INVENTION

In accordance with the present invention, a method for referring to energy units with any monetary system methodology and/or any monetary system methodology language, a method for a particular use is described.

A prominent example would be to use the monetary decimal dollar system methodology language of the United States of America to refer to the general public perceived energy unit “calorie,” henceforth, referred to as “GPP calorie”, which is actually 1 kilocalorie (1000 calories), in which a “GPP calorie” would be equal to 1 penny and 100 “GPP calories” would be equal to 1 U.S. dollar therefore, if a citizen had a daily requirement of 1800 “GPP calories,” it would be represented as $18.00, thus allowing a prominently familiar method for an individual to track energy consumption and needs.

A further example using the same monetary system would be if a citizen were to visit a restaurant and make a purchase of a hamburger that was listed as 360 “GPP calories” using this method; the “GPP calorie” quantity would be represented as $3.60.

Additionally, if a citizen were to purchase a food item with an energy value of $3.60 (360 “GPP calories”) and a drink item with an energy value of $1.40 (140 “GPP calories”) for lunch and a $4.00 (400 “GPP calories”) food item, a $3.50 (350 “GPP calories”) food item, and a $2.10 (210 “GPP calories”) drink item for supper, the citizen could easily add these values and remember the total as the dollar amount it would be represented as. So, the citizen would simply add $3.60+$1.40+$4.00+$3.50+$2.10 equaling a total of $14.60. Then, if the citizen were to go home and have an evening snack of $2.50 (250 “GPP calories”) and a drink of $1.90 (190 “GPP calories”) and added that to the previous total of $14.60, $14.60+$2.50+$1.90 equaling a day's total of $19.00 (1900 “GPP calories”) thus resulting in a $1.00 (100 “GPP calories”) overage from the required $18.00 (1800 “GPP calories”) of energy needed by the citizen. Allowing the citizen in very familiar terms to demonstrate that said citizen has exceeded his/her daily energy needs which, on a consistent basis, will result in obesity.

“GPP calories” have been represented in many ways such as, GPP calories, point systems, portion values, etc. While these other systems for representing “GPP calories” have served public citizens for years, they all require special reference memorization for there particular “GPP calorie” indices. The method described in previous paragraphs in this section is a method with highly familiar elements such as, using the very familiar U.S. dollar system to represent “GPP calories” allowing the citizen to recall a common dollar amount such as $9.25 which has a tendency to be recalled more readily than the larger number 925 “GPP calories” which is typically perceived a bit more ambiguously. The method of the use of any monetary system methodology for the purpose of referring to energy units improves upon any past methods, procedures, systems, or processes by giving a citizen familiar and easily memorable amounts for recollection at a later time.

This method of the use of any monetary system methodology and/or any monetary system methodology language or simile of any monetary system methodology and/ or any monetary system methodology language for the purpose of referring to energy units can be applied in any realm of energy unit reference and can be used commercially to assist both professionals and common citizens in counting, tracking, recording, and other areas of working with energy values.

1. The invention claimed is a method of using any monetary system methodology and/or any monetary system methodology language or the representation of any monetary system methodology and/or any monetary system methodology language for the purpose of referring to any energy unit.
